(19) United States
(12) Patent Application Publication
(10) Pub. No.: US 2025/0054701 A1
(43) Pub. Date: Feb. 13, 2025

(54) MULTILAYER CERAMIC ELECTRONIC COMPONENT AND METHOD FOR MANUFACTURING MULTILAYER CERAMIC ELECTRONIC COMPONENT

(71) Applicant: KYOCERA Corporation, Kyoto-shi, Kyoto (JP)

(72) Inventor: Hisashi SATO, Kirishima (JP)

(73) Assignee: KYOCERA Corporation, Kyoto-shi, Kyoto (JP)

(21) Appl. No.: 18/718,574

(22) PCT Filed: Dec. 8, 2022
(86) PCT No.: PCT/JP2022/045325

§ 371 Date: Jun. 11, 2024

(30) Foreign Application Priority Data
Dec. 23, 2021 (JP) 2021-209892

(51) Int. Cl. H01G 4/30; H01G 4/012

(52) U.S. Cl. CPC H01G 4/30; H01G 4/012

(57) ABSTRACT

A method for manufacturing a multilayer ceramic electronic component includes preparing a stack including dielectric layers and internal electrode layers alternately stacked on one another. The internal electrode layers include ends exposed on a side surface of the stack. The ends extend in a first direction. The method includes applying a laser beam to the side surface in a direction intersecting with the first direction at an incident angle greater than 0° and less than or equal to 90° with respect to the side surface to clean the side surface, forming a dielectric protective layer on the cleaned side surface, and firing the stack with the dielectric protective layer.

### TECHNICAL FIELD

The present disclosure relates to a multilayer ceramic electronic component and a method for manufacturing the multilayer ceramic electronic component.

### BACKGROUND OF INVENTION

A known multilayer ceramic electronic component and a method for manufacturing the multilayer ceramic electronic component are described in, for example, Patent Literature 1.

### CITATION LIST

### Patent Literature

Patent Literature 1: Japanese Unexamined Patent Application Publication No. 2017-120880

### SUMMARY

In an aspect of the present disclosure, a multilayer ceramic electronic component includes a stack, a dielectric protective layer, and voids. The stack includes dielectric layers and internal electrode layers alternately stacked on one another. The internal electrode layers include ends exposed on a side surface of the stack. The dielectric protective layer covers the side surface. The voids are between the dielectric protective layer and the ends. The voids have an average size less than or equal to a thickness of each of the internal electrode layers.

In an aspect of the present disclosure, a method for manufacturing a multilayer ceramic electronic component includes preparing a stack including dielectric layers and internal electrode layers alternately stacked on one another. The internal electrode layers include ends exposed on a side surface of the stack. The ends extend in a first direction. The method includes applying a laser beam to the side surface in a direction intersecting with the first direction at an incident angle greater than 0° and less than or equal to 90° with respect to the side surface to clean the side surface, covering the cleaned side surface with a dielectric protective layer, and firing the stack with the dielectric protective layer.

### BRIEF DESCRIPTION OF THE DRAWINGS

The objects, features, and advantages of the present disclosure will become more apparent from the following detailed description and the drawings.

FIG. 1 is a perspective view of a multilayer ceramic electronic component according to one or more embodiments of the present disclosure.

FIG. 2 is a perspective view of a base component of the multilayer ceramic electronic component in FIG. 1.

FIG. 3 is a perspective view of a precursor of the base component in FIG. 2.

FIG. 4 is a cross-sectional view taken along line IV-IV in FIG. 1.

FIG. 5 is a perspective view of a ceramic green sheet on which a conductive paste is printed.

FIG. 6 is an external view of multiple ceramic green sheets in FIG. 5 stacked on one another.

FIG. 7 is a perspective view of a multilayer base.

FIG. 8 is a perspective view of multiple base precursors cut from the multilayer base.

FIG. 9 is a perspective view of the base precursors rotated to have uncovered side surfaces.

FIG. 10A is a cross-sectional view of a side surface of a stack during laser cleaning, illustrating formation of a dielectric protective layer with a known method for manufacturing a multilayer ceramic electronic component.

FIG. 10B is a cross-sectional view of the side surface of the stack after laser cleaning, illustrating the formation of the dielectric protective layer with the known method for manufacturing a multilayer ceramic electronic component.

FIG. 10C is a cross-sectional view of a joint between the dielectric protective layer and the stack in a fired base component, illustrating the formation of the dielectric protective layer with the known method for manufacturing a multilayer ceramic electronic component.

FIG. 11A is a cross-sectional view of a side surface of a stack during laser cleaning, illustrating formation of a dielectric protective layer with a method for manufacturing the multilayer ceramic electronic component according to one or more embodiments of the present disclosure.

FIG. 11B is a cross-sectional view of the side surface of the stack after laser cleaning, illustrating the formation of the dielectric protective layer with the method for manufacturing the multilayer ceramic electronic component according to one or more embodiments of the present disclosure.

FIG. 11C is a cross-sectional view of a joint between the dielectric protective layer and the stack in a fired base component, illustrating the formation of the dielectric protective layer with the method for manufacturing the multilayer ceramic electronic component according to one or more embodiments of the present disclosure.

FIG. 12A is a side view of the stack illustrating laser cleaning with the method for manufacturing the multilayer ceramic electronic component according to one or more embodiments of the present disclosure.

FIG. 12B is a side view of the stack as viewed in a direction different from the direction in FIG. 12A.

FIG. 13A is a diagram of stacks fixed to a base with an adhesive releasable sheet between the stacks and the base, illustrating a process of forming the dielectric protective layer.

FIG. 13B is a diagram of the stacks pressed against a ceramic green sheet on a resin sheet, illustrating the process of forming the dielectric protective layer.

FIG. 13C is a diagram of the stacks lifted upward with the ceramic green sheet adhering to the side surfaces of the stacks, illustrating the process of forming the dielectric protective layer.

FIG. 14 is a perspective view of the stacks with dielectric protective layers.

### DESCRIPTION OF EMBODIMENTS

A multilayer ceramic electronic component and a method for manufacturing the multilayer ceramic electronic component with the structure that forms the basis of a multilayer ceramic electronic component and a method for manufacturing the multilayer ceramic electronic component according to one or more embodiments of the present disclosure will be described first.

Recent small and highly functional electronic devices are to incorporate smaller electronic components. A multilayer ceramic capacitor as an example of the multilayer ceramic electronic component typically has a length of 1 mm or less on each side. The multilayer ceramic capacitor is to be further smaller and to have larger capacity.

To be smaller and have larger capacity, the multilayer ceramic capacitor can have thinner insulating margins around internal electrode layers. To have thinner insulating margins, some methods include cutting a multilayer base including dielectric layers and internal electrode layers alternately stacked on one another into stacks with the internal electrode layers exposed on the side surfaces, and then additionally forming dielectric protective layers to be insulating margins on the side surfaces of the stacks. Such a method involves removing any foreign objects, such as debris from cutting the multilayer base, from the side surfaces of the stacks before forming the dielectric protective layers. Patent Literature 1 describes a method for manufacturing a multilayer ceramic capacitor including cleaning the side surfaces of stacks by laser application.

A known manufacturing method can cause varying offset distances of internal electrode layers from side surfaces of stacks, possibly forming defective dielectric protective layers and degrading the characteristics and the reliability of the multilayer ceramic electronic component.

The multilayer ceramic electronic component and the method for manufacturing the multilayer ceramic electronic component according to one or more embodiments of the present disclosure will now be described with reference to the drawings. A multilayer ceramic capacitor will now be described as an example of the multilayer ceramic electronic component. However, in one or more embodiments of the present disclosure, the multilayer ceramic electronic component is not limited to the multilayer ceramic capacitor, and may be, for example, a multilayer piezoelectric element, a multilayer thermistor element, a multilayer chip coil, or a multilayer ceramic substrate. In one or more embodiments of the present disclosure, the method for manufacturing the multilayer ceramic capacitor allows manufacture of, in addition to the multilayer ceramic capacitor, various multilayer ceramic electronic components, such as a multilayer piezoelectric element, a multilayer thermistor element, a multilayer chip coil, and a multilayer ceramic substrate. The drawings referred to below are schematic and may not be drawn to scale relative to, for example, the actual dimensional ratios. For ease of explanation, some of the drawings are defined using the orthogonal XYZ coordinate system, with the positive Z-direction being upward to use the terms such as an upper surface or a lower surface. The X-direction may be referred to as a first direction. The Y-direction may be referred to as a second direction. The Z-direction may be referred to as a third direction.

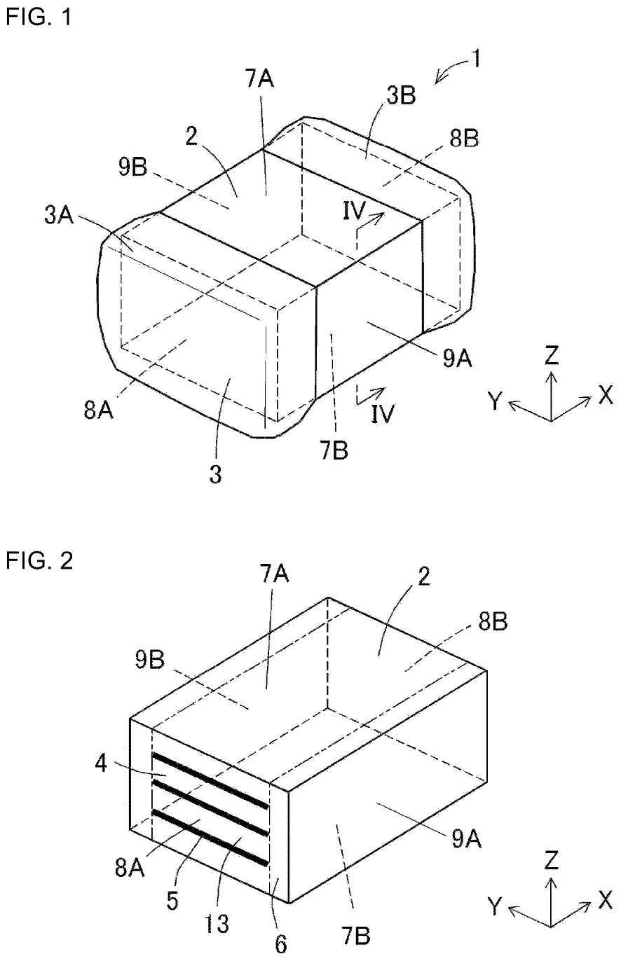

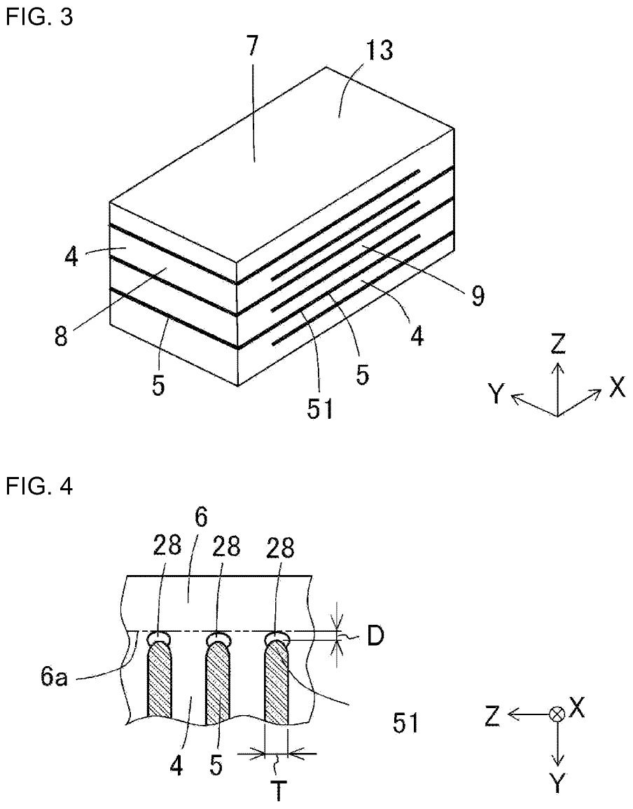

The multilayer ceramic capacitor according to one or more embodiments of the present disclosure will now be described. FIG. 1 is a perspective view of the multilayer ceramic capacitor according to one or more embodiments of the present disclosure. FIG. 2 is a perspective view of a base component of the multilayer ceramic capacitor in FIG. 1. FIG. 3 is a perspective view of a precursor of the base component in FIG. 2. FIG. 4 is a cross-sectional view taken along line IV-IV in FIG. 1. FIG. 2 is a view of the base component after firing, as well as before firing. The base component shrinks after firing, but has the same structure as before firing. Similarly or in the same manner, FIG. 3 is a view of a stack after firing, as well as before firing.

In one or more embodiments of the present disclosure, a multilayer ceramic capacitor 1 includes a stack 13 and dielectric protective layers 6. As illustrated in FIG. 1, the multilayer ceramic capacitor 1 may include external electrodes 3 for external electrical connection. As illustrated in FIG. 2, the stack 13 and the dielectric protective layers 6 are included in a base component 2. The stack 13 is the precursor of the base component 2 and is also referred to as a base precursor 13. The dielectric protective layers 6 are also referred to as protective layers 6.

As illustrated in FIG. 3, the stack 13 includes dielectric layers 4 and internal electrode layers 5 alternately stacked in the third direction (Z-direction). The stack 13 is substantially a rectangular prism. The stack 13 includes a first surface 7A and a second surface 7B opposite to each other in the third direction. The stack 13 includes a first end face 8A and a second end face 8B opposite to each other in the first direction (X-direction), and a first side surface 9A and a second side surface 9B opposite to each other in the second direction (Y-direction). The first surface 7A and the second surface 7B may be collectively referred to as main surfaces 7. The first end face 8A and the second end face 8B may be collectively referred to as end faces 8. The first side surface 9A and the second side surface 9B may be collectively referred to as side surfaces 9.

The dielectric layers 4 include an insulating material. The dielectric layers 4 may include, for example, a ceramic material such as BaTiO₃ (barium titanate), CaTiO₃ (calcium titanium), SrTiO₃ (strontium titanate), or BaZrO₃ (barium zirconate).

Thinner dielectric layers 4 increase the capacitance of the multilayer ceramic capacitor 1. Each dielectric layer 4 may have a thickness of, for example, 0.5 to 10 μm.

The internal electrode layers 5 include a conductive material. The internal electrode layers 5 may include, for example, a metal material such as Ni (nickel), Cu (copper), Ag (silver), Sn (tin), Pt (platinum), Pd (palladium), or Au (gold), or an alloy material containing these metal materials.

As illustrated in FIG. 3, the internal electrode layers 5 are exposed on the first side surface 9A and the second side surface 9B. The internal electrode layers 5 include ends 51 exposed on the side surfaces 9. The ends 51 extend in the first direction. The internal electrode layers 5 with one polarity are exposed on one of the first end face 8A or the second end face 8B, and the internal electrode layers 5 with the other polarity are exposed on the other of the first end face 8A or the second end face 8B.

The internal electrode layers 5 with a smaller thickness T that allow the capacitor to function reduce internal defects caused by internal stress, improving the reliability of the multilayer ceramic capacitor 1. For a multilayer ceramic capacitor 1 with a stack of many layers, the internal electrode layers 5 may each have, for example, a thickness T of 0.4 to 1.0 μm.

The protective layers 6 include an insulating material. The protective layers 6 may include a ceramic material such as BaTiO₃, CaTiO₃, SrTiO₃, or BaZrO₃. The protective layers 6 may include the same ceramic material as the dielectric layers 4.

One of the protective layers 6 is located on the first side surface 9A and covers the internal electrode layers 5 exposed on the first side surface 9A. The other of the protective layers 6 is located on the second side surface 9B and covers the internal electrode layers 5 exposed on the second side surface 9B.

As illustrated in FIG. 1, the external electrodes 3 include a first external electrode 3A and a second external electrode 3B. The first external electrode 3A is located on the first end face 8A and electrically connected to the internal electrode layers 5 exposed on the first end face 8A. The second external electrode 3B is located on the second end face 8B and electrically connected to the internal electrode layers 5 exposed on the second end face 8B. The external electrodes 3 extend to the first surface 7A and the second surface 7B. The first external electrode 3A extends to the first side surface 9A and the second side surface 9B to cover portions of the protective layers 6 adjacent to the first end face 8A. The second external electrode 3B extends to the first side surface 9A and the second side surface 9B to cover portions of the protective layers 6 adjacent to the second end face 8B. The first external electrode 3A and the second external electrode 3B are electrically insulated from each other.

Each external electrode 3 may include an underlayer connected to the base component 2 and a plated outer layer that facilitates mounting by soldering. The underlayer may be applied to, by thermal treatment, the base component 2 after firing or may be applied to the base component 2 before firing and fired together with the base component 2. The underlayer may be formed by direct plating. The underlayer and the plated outer layer may each be single-layered or multilayered. The underlayer and the plated outer layer may include, for example, a metal material such as Ni, Cu, Ag, Pd, or Au, or an alloy material containing these metal materials. The underlayer and the plated outer layer may include a conductive resin layer as an intermediate layer or an outer layer.

On the side surfaces 9 of the stack 13, positive internal electrode layers 5 and negative internal electrode layers 5 are adjacent to one another with the dielectric layers 4 between them. In the present embodiment, the protective layers 6 are located on the first side surface 9A and the second side surface 9B to electrically insulate the internal electrode layers 5 with different polarities from each other and to physically protect the ends 51. The protective layers 6 may include a ceramic material. In this case, the protective layers 6 can be insulating and have relatively high mechanical strength. With the protective layers 6 including a ceramic material, the stack 13 and the protective layers 6 can be fired together. The boundaries between the stack 13 and the protective layers 6 indicated by the two-dot-dash lines in FIG. 2 actually appear unclear.

Thinner protective layers 6 allow the multilayer ceramic capacitor 1 to be smaller and to have larger capacity. Each protective layer 6 may have a thickness of, for example, 5 to 40 μm.

In the multilayer ceramic capacitor 1, voids 28 are between the protective layers 6 and the ends 51 of the internal electrode layers 5. As illustrated in FIG. 4, the voids 28 are between a joint surface 6a of the protective layer 6 joined to the stack 13 and the ends 51 of the internal electrode layers 5. In the present embodiment, the voids 28 have an average size D_{AVG} less than or equal to the thickness T of the internal electrode layers 5. The voids 28 between the protective layers 6 and the ends 51 of the internal electrode layers 5 reduce the likelihood of short-circuiting between adjacent internal electrode layers 5. The voids 28 having the average size D_{AVG} less than or equal to the thickness T of the internal electrode layer 5, or in other words, the side surfaces 9 having relatively less unevenness, increase the joining strength between the protective layers 6 and the stack 13. This reduces degradation in characteristics and reliability caused by formation of defective protective layers 6.

The average size D_{AVG} is the average of sizes D of the voids 28. The sizes D of the voids 28 can be calculated by, for example, observing a cut surface of the multilayer ceramic capacitor 1 taken parallel to the end faces 8 using a scanning electron microscope (SEM). As illustrated in FIG. 4, the sizes D of the voids 28 may be dimensions of the voids 28 in the second direction (Y-direction) appearing on the cut surface. The sizes D of the voids 28 may be the circular equivalent diameters of the voids 28 appearing on the cut surface. The sizes D of the voids 28 may be calculated by image analysis of the cut surface using commercially available image analysis software.

When the internal electrode layers 5 each have the thickness T of 0.4 to 1.0 μm, the average size D_{AVG} of the voids 28 may be 0.1 to 0.5 μm, which is less than or equal to the half of the thickness T of the internal electrode layers 5. This increases the capacity and the reliability of the multilayer ceramic capacitor 1.

The method for manufacturing the multilayer ceramic capacitor according to one or more embodiments of the present disclosure will now be described.

A ceramic mixture powder containing a ceramic material as a material of the dielectric layers 4 and an additive is first wet-ground and mixed using a bead mill and then mixed with a polyvinyl butyral binder, a plasticizer, and an organic solvent to prepare ceramic slurry. The ceramic material may be, for example, BaTiO₃, CaTiO₃, SrTiO₃, or BaZrO₃.

The ceramic slurry is then applied onto a carrier film with a sheet forming method using, for example, a die coater, a doctor blade coater, or a gravure coater to form a ceramic green sheet 10. The ceramic green sheet 10 may have a thickness of, for example, 0.5 to 10 μm. A thinner ceramic green sheet 10 can increase the capacitance of the multilayer ceramic capacitor.

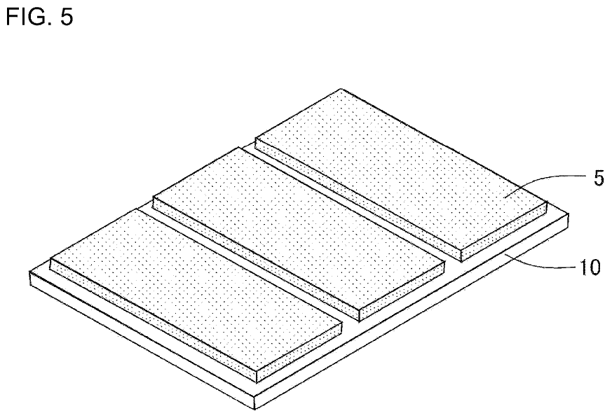

A conductive paste to be the internal electrode layers 5 is then prepared using a powder mainly containing a metal material such as Ni, Cu, Ag, Sn, Pt, Pd, or Au or an alloy material containing these metal materials. Subsequently, the prepared conductive paste is printed on the ceramic green sheet 10 in strip patterns in multiple rows by, for example, gravure printing or screen printing. FIG. 5 is a schematic diagram of the ceramic green sheet 10 on which the conductive paste is printed. The ceramic green sheet 10 may be hereafter referred to as a dielectric layer 4. The conductive paste printed on the ceramic green sheet 10 may be hereafter referred to as an internal electrode layer 5.

Thinner internal electrode layers 5 that allow the capacitor to function improve the reliability of the multilayer ceramic capacitor 1. For a multilayer ceramic capacitor 1 with a stack of many layers, the internal electrode layers 5 may each have, for example, the thickness T of 0.4 to 1.0 μm.

As illustrated in FIG. 6, a predetermined number of ceramic green sheets 10 are stacked on one another, on which a predetermined number of ceramic green sheets 10 with the internal electrode layers 5 printed are stacked in a manner deviating by a predetermined distance from one another, and a predetermined number of ceramic green sheets 10 are finally stacked. The predetermined distance may be half the dimension of each internal electrode layer 5 in strip patterns (refer to FIG. 5) in the width direction. FIG. 6 is a schematic external view of stacked ceramic green sheets 10 on some of which the internal electrode layers 5 are printed. Although not illustrated in FIG. 6, the ceramic green sheets 10 are stacked on a support sheet. The support sheet may be an adhesive releasable sheet, such as a low-tack sheet or a foam releasable sheet.

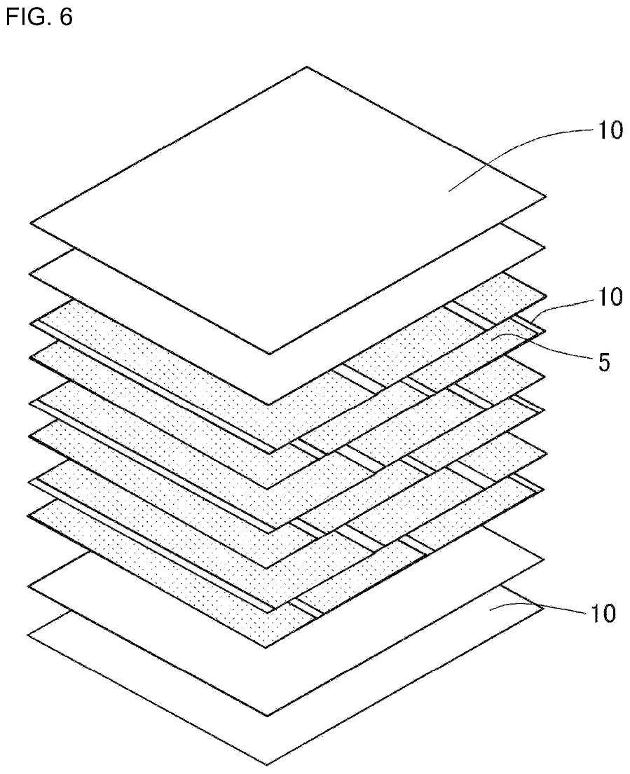

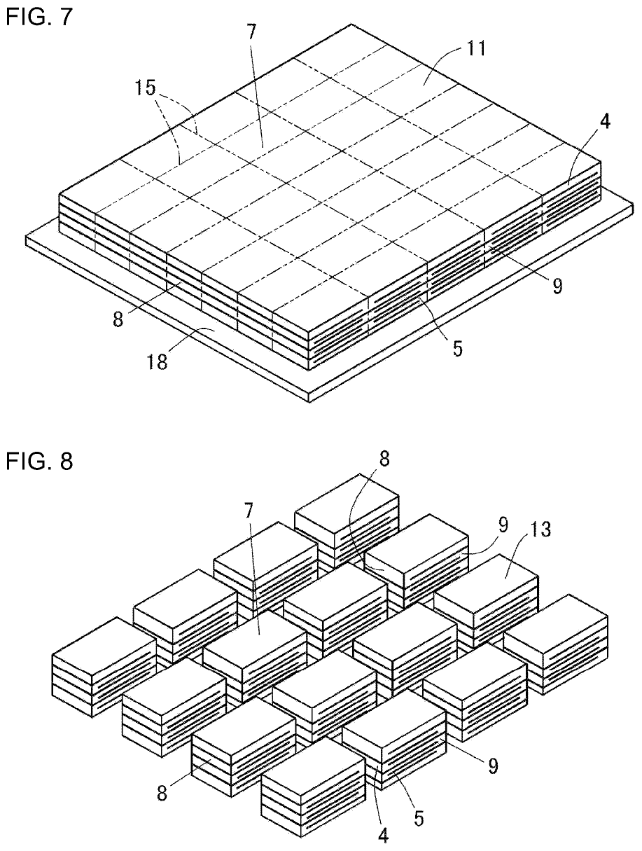

The stack of the ceramic green sheets 10 is then pressed in the stacking direction to obtain a multilayer base 11 including the ceramic green sheets 10 integral with one another as illustrated in, for example, FIG. 7. The multilayer base 11 may be pressed using, for example, a hydrostatic press device. In FIG. 7, imaginary separation lines 15 on a surface of the multilayer base 11 are indicated by the two-dot-dash lines. Each stack sectioned by the imaginary separation lines 15 corresponds to the stack 13 illustrated in FIG. 3. The multilayer base 11 includes main surfaces 7, end faces 8, and side surfaces 9 corresponding to the respective main surfaces 7, end faces 8, and side surfaces 9 of the stack 13. As illustrated in FIG. 7, the support sheet 18 (referred to as an adhesive releasable sheet in some examples) used in stacking the ceramic green sheets 10 is located on one of the main surfaces 7 of the multilayer base 11.

The multilayer base 11 is then cut along the imaginary separation lines 15 to obtain multiple stacks 13 illustrated in FIG. 8. The multilayer base 11 may be cut with, for example, a dicing saw or a press-cutter. The end faces 8 and the side surfaces 9 of each stack 13 may be the cut surfaces of the multilayer base 11. The stacks 13 each include the internal electrode layers 5 exposed on their side surfaces 9. The internal electrode layers 5 are stacked alternately with the dielectric layers 4. The internal electrode layers 5 with different polarities are exposed on different end faces 8 of the stacks 13.

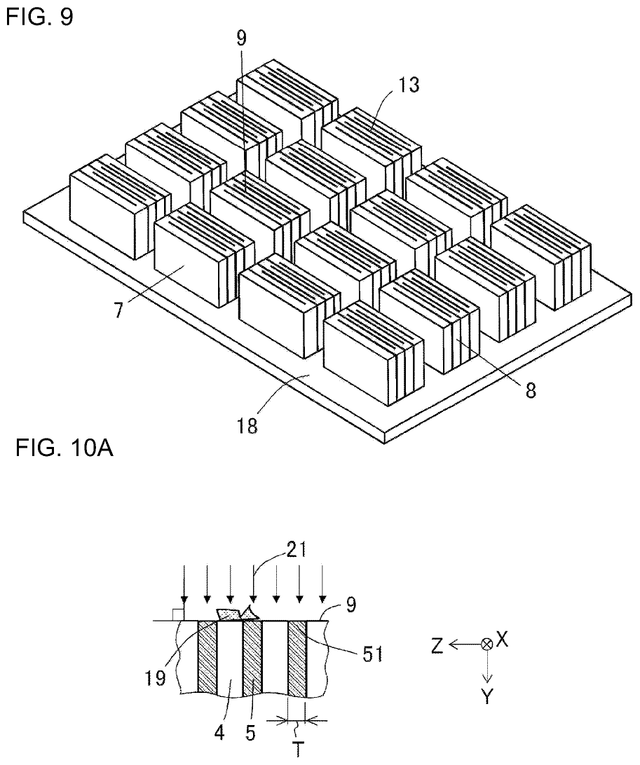

As illustrated in FIG. 9, the stacks 13 are then rotated by 90 degrees about an axis perpendicular to the end faces 8 on the support sheet 18 to uncover one of the side surfaces 9. In other words, each stack 13 is rotated to have one of the side surfaces 9 facing the support sheet 18. For example, the stacks 13 may be placed into pockets of an aligner and rotated by a magnetic force in a magnetic field applied externally. The stacks 13 may be rotated in a manner other than by the magnetic force. For example, the base precursors 13 in FIG. 7 may be held between two elastic plates and rolled by sliding the elastic plates in opposite directions.

The stacks 13 can have foreign objects 19, such as debris from cutting the multilayer base 11, adhering to the side surfaces 9. The internal electrode layers 5 with different polarities are exposed adjacent to one another on the side surfaces 9 of the stacks 13. Foreign objects 19 of metal contained in the cutting debris on the side surfaces 9 can cause short-circuiting between internal electrode layers 5 with different polarities. To manufacture a multilayer ceramic capacitor with high reliability, the foreign objects 19 on the side surfaces 9 are to be removed.

To remove the foreign objects adhering to the side surfaces 9 (hereafter also referred to as cleaning target surfaces), the side surfaces 9 are cleaned with laser beams. Laser cleaning vaporizes and removes foreign objects adhering to the cleaning target surfaces 9 by applying laser beams (hereafter, simply referred to as lasers) to the cleaning target surfaces 9. Laser cleaning using no solvent is environmentally friendly, and is thus effectively used as a process performed before formation of the protective layers 6 on the side surfaces 9. In laser cleaning, short pulse lasers are applied to the cleaning target surfaces 9 to cause foreign objects adhering to the cleaning target surfaces 9 to absorb energy and vaporize. In laser-etching cleaning, plasma promptly forms on the cleaning target surfaces 9, and the shock wave and thermal expansion pressure of the plasma remove the foreign objects and the surface layers. The lasers for the laser cleaning may be yttrium aluminum garnet (YAG) lasers or harmonic lasers of the YAG lasers. The lasers for the laser cleaning may also be a gas laser such as an excimer laser or a carbon gas laser.

The side surfaces 9 of the stacks 13 include the dielectric layers 4 and the internal electrode layers 5 alternating one another. When laser beams are applied to the side surfaces 9, the internal electrode layers 5 are selectively and preferentially etched and are offset from the side surfaces 9. The offset internal electrode layers 5 can avoid contact short-circuiting with adjacent internal electrode layers 5. However, the offset internal electrode layers 5, particularly the offset internal electrode layers 5 with greater offset distances, can cause sintering deformation of the dielectric layers 4 during firing of the base components 2. This may easily change the thickness or cause cracks in the dielectric layers 4 between offset internal electrode layers 5. This can also form large voids at the joints between the stack and the protective layers, possibly reducing reliability in, for example, withstand voltage characteristics.

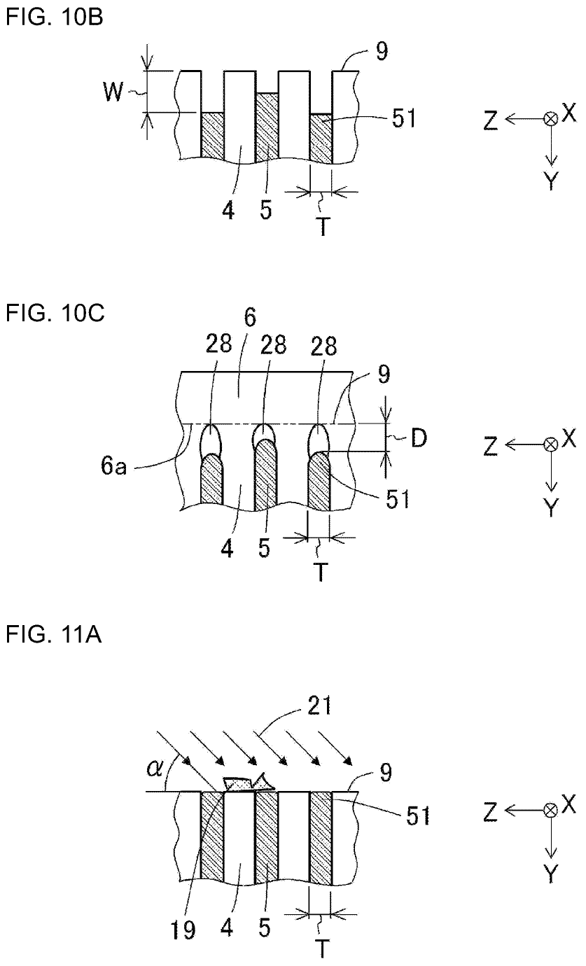

FIGS. 10A to 10C are cross-sectional views of a stack illustrating formation of a protective layer with a known method for manufacturing a multilayer ceramic electronic component. The cross-sectional views in FIGS. 10A to 10C correspond to the cross-sectional view in FIG. 4. In laser cleaning illustrated in FIG. 10A, laser beams 21 emitted from a laser device 20 are applied to a side surface 9 as a cleaning target surface 9 in a direction perpendicular to the cleaning target surface 9. The intensity of the laser beams 21 in the laser cleaning is set to allow foreign objects on the cleaning target surface to be removed and to allow ends 51 of internal electrode layers 5 to vaporize without major damage to the cleaning target surface 9. When the laser beams 21 are applied perpendicularly to the cleaning target surface 9, the internal electrode layers 5 vaporize and are removed preferentially over the dielectric layers 4. The side surface 9 after the laser cleaning thus has various offset distances W of the internal electrode layers 5 as illustrated in FIG. 10B. As illustrated in FIG. 10B, the offset distance W herein refers to the distance between the side surface 9 of the stack 13 and a portion of the surface of each internal electrode layer 5 facing the side surface 9 and farthest from the side surface 9.

The internal electrode layers 5 are etched at a higher rate than the dielectric layers 4. This is mainly caused by the difference in decomposition temperature between the ceramic material and the metal material. The laser beams 21 applied to the internal electrode layers 5 enter into the internal electrode layers 5. The offset distances W of the internal electrode layers 5 thus vary based on the microscopic composition distribution or the formation state of the internal electrode layers 5.

The offset distances W of the internal electrode layers 5 also vary based on whether the foreign objects 19 are on the cleaning target surface 9. When foreign objects 19 are on the cleaning target surface 9, a portion of the cleaning target surface 9 with no foreign objects 19 is offset (etched) farther while the foreign objects 19 are being removed. The offset distances W of the internal electrode layers 5 thus vary greatly as affected by foreign objects 19. Similarly or in the same manner, when the cleaning target surface 9 is scanned with the laser beams 21, the entering depth of the laser beams 21 into the internal electrode layers 5 varies based on the manner in which the laser beams 21 are applied to the cleaning target surface 9.

The irradiation spot at which the laser beams 21 are applied typically has a smaller area than the cleaning target surface 9. The cleaning target surface 9 is thus to be covered with many irradiation spots. To reliably remove the surface layer of the cleaning target surface 9, peripheries of the laser beam irradiation spots are to overlap one another. However, in a portion including an overlap mark resulting from overlap of the irradiation spots, larger voids 28 can form at the ends 51 of the internal electrode layers 5, possibly causing formation of defective protective layers 6.

As described above, when the laser beams 21 are applied perpendicularly to the cleaning target surface 9, the offset distances W vary greatly. The voids 28 in the base component 2 after firing are thus likely to be larger, as illustrated in FIG. 10C. This may cause formation of defective protective layers 6, reducing the reliability of the multilayer ceramic capacitor.

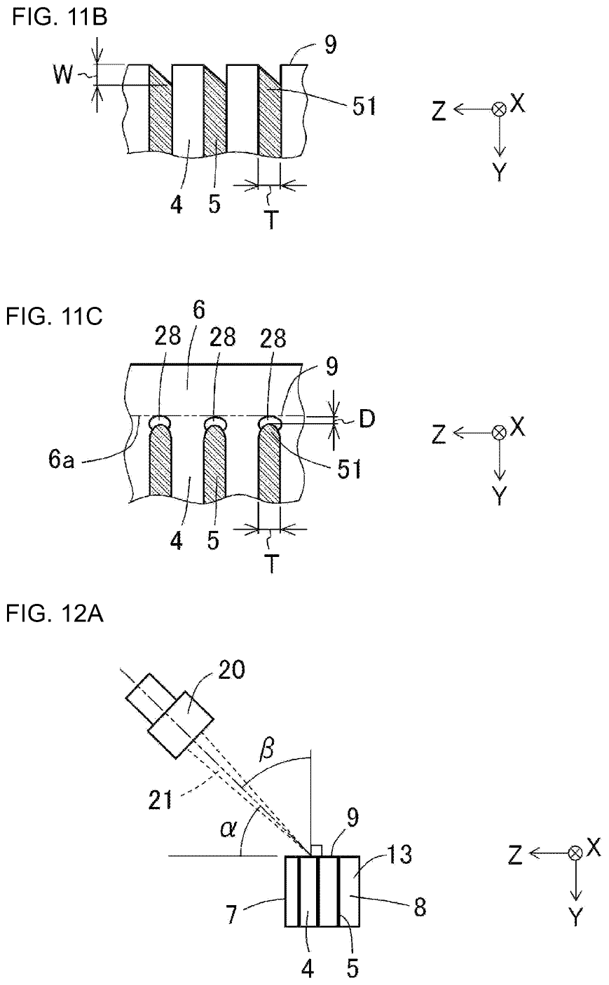

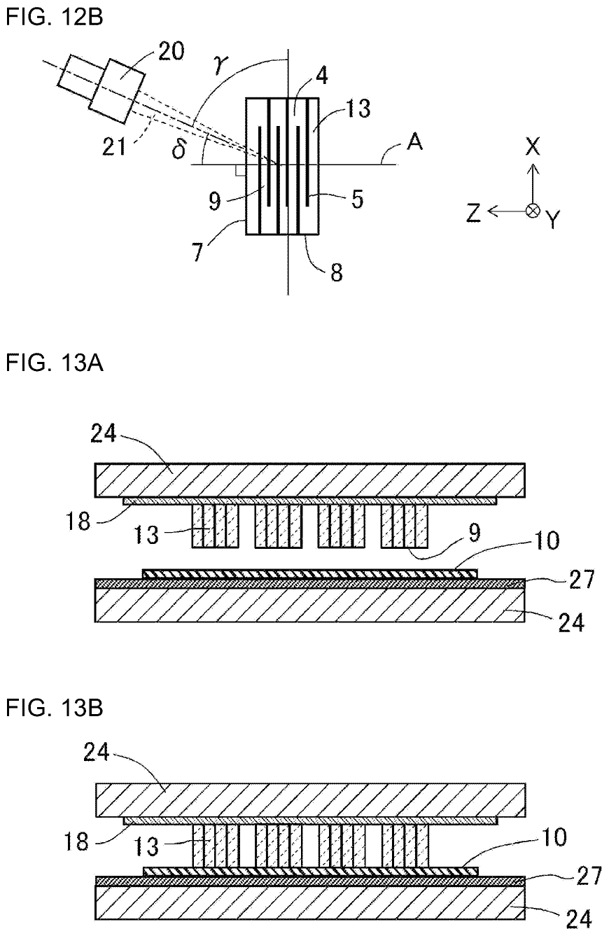

FIGS. 11A to 11C are cross-sectional views of a stack illustrating formation of the protective layers with the method for manufacturing the multilayer ceramic electronic component according to one or more embodiments of the present disclosure. FIGS. 12A and 12B are side views of the stack illustrating laser cleaning with the method for manufacturing the multilayer ceramic electronic component according to one or more embodiments of the present disclosure. The cross-sectional views in FIGS. 11A to 11C correspond to the cross-sectional view in FIG. 4. In the present embodiment, with the method for manufacturing the multilayer ceramic electronic component, the laser beams 21 are applied to the side surface 9 in a direction intersecting with the first direction (direction in which the ends 51 of the internal electrode layers 5 extend) at an inclination angle α of 0° or greater and less than 90° with respect to the side surface 9, as illustrated in FIGS. 11A and 12A. In other words, with the manufacturing method in the present embodiment, the laser beams 21 are applied to the side surface 9 in the direction intersecting with the first direction at an incident angle β greater than 0° and less than or equal to 90° with respect to the side surface 9.

With the laser beams 21 applied at an angle, the internal electrode layers 5, which are more likely to be etched than the dielectric layers 4, are shadowed by the dielectric layers 4. The internal electrode layers 5 are thus less likely to be offset (etched) farther, reducing variations in the offset distances Was illustrated in FIG. 11B. For a portion of the cleaning target surface 9 with foreign objects 19, the internal electrode layers 5 are shadowed by the dielectric layers 4 while the foreign objects 19 are being removed. The internal electrode layers 5 are thus not etched farther greatly. As illustrated in FIG. 11B, the offset distance W is thus relatively uniform across the cleaning target surface 9. The laser beams 21 applied at an angle reduce variations in the offset distances W. The voids 28 in the base component 2 after firing can thus be smaller and with less variations, as illustrated in FIG. 11C. This reduces short-circuiting between the internal electrode layers 5 with different polarities and reduces degradation in characteristic and reliability caused by formation of defective protective layers 6, allowing the manufacture of the multilayer ceramic capacitor 1 with high reliability.

When the laser beams 21 are applied at overlapping irradiation spots, the dielectric layers 4 are etched at a controlled etching rate, with smaller overlap marks and thus reduced formation of defective protective layers 6. This allows a multilayer ceramic capacitor with high reliability to be manufactured efficiently.

When the laser beams 21 have an inclination angle α greater than or equal to 0° and less than 90° with respect to the cleaning target surface 9, or in other words, have an incident angle β greater than 0° and less than or equal to 90° with respect to the cleaning target surface 9, the average size D_{AVG} of the voids 28 can be less than or equal to the thickness T of the internal electrode layers 5.

The laser beams 21 may have an inclination angle α less than or equal to 60°. In other words, the laser beams 21 may have an incident angle β greater than 30°. This allows, when the internal electrode layers 5 has a thickness T of 0.4 to 1.0 μm, the average size D_{AVG} of the voids 28 in the base component 2 after firing to be less than or equal to the thickness T of the internal electrode layers 5, or for example, to be 0.1 to 0.5 μm, thus allowing the manufacture of the multilayer ceramic capacitor 1 with larger capacity and higher reliability. The thickness T of the internal electrode layers 5 may be measured before or after firing of the stack 13.

As illustrated in FIG. 12B, when viewed in the direction perpendicular to the cleaning target surface 9, the laser beams 21 may be applied in a direction forming an angle δ of +30° with an axis A perpendicular to the main surfaces 7. In other words, when viewed in the direction perpendicular to the cleaning target surface 9, the laser beams 21 may be applied in a direction at an angle γ of 60° or greater with the first direction in which the ends 51 extend. This allows the average size D_{AVG} of the voids 28 to be less than or equal to the thickness T of the internal electrode layers 5 and the cleaning target surface 9 to be scanned efficiently with the laser beams 21, allowing the multilayer ceramic capacitor 1 with high reliability to be manufactured efficiently.

After the first side surfaces 9A of the stacks are cleaned with lasers, the second side surfaces 9B are also cleaned with lasers. To uncover the second side surfaces 9B, a support sheet different from the support sheet 18 holding the stacks 13 may be used. The different support sheet is an adhesive sheet that is releasable at higher temperatures than the support sheet 18. The different support sheet is attached to the uncovered first side surfaces 9A that has been cleaned. The support sheet 18 is then heated and removed. The stacks 13 with the first side surfaces 9A supported by the different support sheet have the second side surfaces 9B being uncovered.

Subsequently, the cleaned side surface 9 is covered with the protective layers 6 as a ceramic green sheet 10. FIGS. 13A to 13C are diagrams each illustrating a process of attaching the ceramic green sheet 10 to be the protective layers 6 to the first side surfaces 9A of the stacks 13 (the lower surface of the stacks 13 in FIG. 13A).

In FIG. 13A, the second side surfaces 9B (upper surfaces of the stacks 13 in FIG. 13A) of the stacks 13 are fixed to a base 24 with the adhesive releasable sheet 18 between the second side surfaces 9B and the base 24.

In FIG. 13B, the stacks 13 are pressed against the ceramic green sheet 10 on a resin sheet 27. Although the ceramic green sheet 10 is attached to the side surfaces 9 in the state illustrated in FIG. 13B, the ceramic green sheet 10 may be attached more firmly by using an adhesive ceramic green sheet 10 as the ceramic green sheet 10 to be the protective layers 6 or heating the ceramic green sheet 10 to be the protective layers 6 in press-bonding to the stacks 13. In other examples, an adhesive medium that does not affect final products may be used. The ceramic green sheet 10 to be the protective layers 6 may be single-layered. The ceramic green sheet 10 to be the protective layers 6 may be multilayered. In this case, the layers in the multilayer ceramic green sheet 10 may include different components.

In FIG. 13C, the base 24 is lifted upward, with the ceramic green sheet 10 adhering to the first side surfaces 9A of the stacks 13. Portions of the surface of the ceramic green sheet 10 not in contact with the stacks 13 remain on the resin sheet 27, thus forming the protective layers 6 as the ceramic green sheet 10 on the first side surfaces 9A of the stacks 13. The ceramic green sheet 10 may have lower rupture strength.

In the example illustrated in FIGS. 13A to 13C, the protective layers 6 as the ceramic green sheet 10 are formed on the first side surfaces 9A and then on the second side surfaces 9B. However, the protective layers 6 as the ceramic green sheet 10 may be formed on the first side surfaces 9A and the second side surfaces 9B at the same time. Although the ceramic green sheet 10 is attached to the lower surface of the stacks 13 from below in FIGS. 13A to 13C, the orientation in each of FIGS. 13A to 13C may be inverted. In other words, the ceramic green sheet 10 to be the protective layers 6 may be pressed from above against the upper surfaces of the stacks 13 fixed on the base 24 with the adhesive releasable sheet 18 between the upper surfaces and the base 24 to form the protective layers 6 as the ceramic green sheet 10.

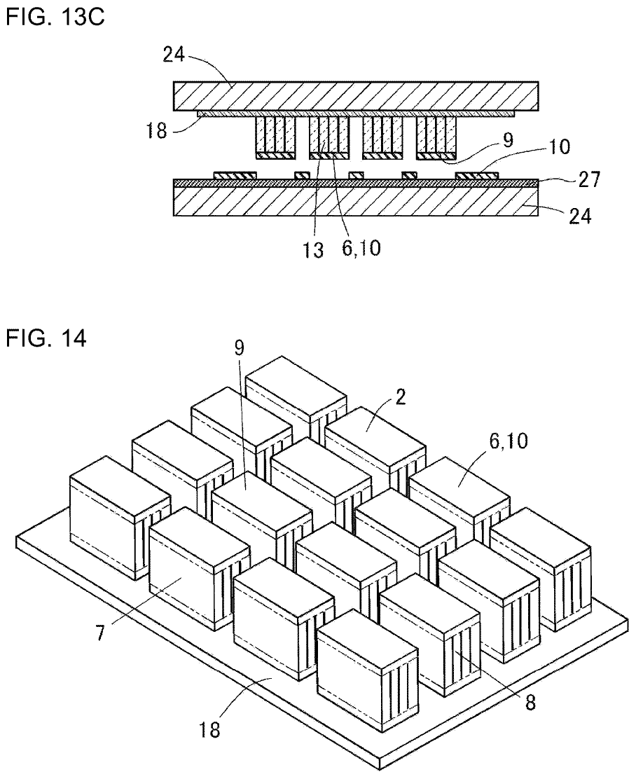

After or during formation of the protective layers 6 as the ceramic green sheet 10 on both the side surfaces 9, the stacks 13 with the ceramic green sheet 10 to be the protective layers 6 adhering to the side surfaces 9 may be pressed to firmly bond the ceramic green sheet 10 to be the protective layers 6 to the side surfaces 9. FIG. 14 is a perspective view of the stacks 13 including the ceramic green sheets 10 to be the protective layers 6 on their first side surfaces 9A and second side surfaces 9B. The stacks 13 are in the same state as the base components 2 before firing.

The stacks 13 with the ceramic green sheet 10 to be the protective layers 6 are degreased in a nitrogen atmosphere, and then fired in a mixed atmosphere containing hydrogen or nitrogen to obtain the base components 2 illustrated in FIG. 2. The conductive paste to be the external electrodes 3 is then applied to the obtained base components 2 and baked to form the external electrodes 3. This completes the multilayer ceramic capacitors 1 illustrated in FIG. 1.

The protective layers 6 may be formed by attaching the ceramic green sheet 10 to the side surfaces 9 or applying ceramic slurry to the side surfaces 9 and drying the ceramic slurry.

The multilayer ceramic electronic component according to one or more embodiments of the present disclosure may be implemented in forms 1 to 3 described below.
(1) A multilayer ceramic electronic component, comprising:
a stack including dielectric layers and internal electrode layers alternately stacked on one another, the internal electrode layers including ends exposed on a side surface of the stack;
a dielectric protective layer covering the side surface; and
voids being between the dielectric protective layer and the ends, and having an average size less than or equal to a thickness of each of the internal electrode layers.
(2) The multilayer ceramic electronic component according to (1), wherein each of the internal electrode layers has a thickness of 0.4 to 1.0 μm inclusive.
(3) The multilayer ceramic electronic component according to (1) or (2), wherein the voids have an average size of 0.1 to 0.5 μm inclusive.

The method for manufacturing the multilayer ceramic electronic component according to one or more embodiments of the present disclosure may be implemented in forms 4 to 6 described below.
(4) A method for manufacturing a multilayer ceramic electronic component, the method comprising:
preparing a stack including dielectric layers and internal electrode layers alternately stacked on one another, the internal electrode layers including ends exposed on a side surface of the stack, the ends extending in a first direction;
applying a laser beam to the side surface in a direction intersecting with the first direction at an incident angle greater than 0° and less than or equal to 90° with respect to the side surface to clean the side surface;
covering the cleaned side surface with a dielectric protective layer; and
firing the stack with the dielectric protective layer.
(5) The method according to (4), wherein
the incident angle is greater than 30°.
(6) The method according to (4) or (5), wherein
the laser beam travels in a direction at an angle greater than or equal to 60° with the first direction when viewed in a direction perpendicular to the side surface.

In one or more embodiments of the present disclosure, the multilayer ceramic electronic component has less degradation in characteristics and reliability caused by formation of defective dielectric protective layers, and is highly reliable. In one or more embodiments of the present disclosure, the method for manufacturing the multilayer ceramic electronic component allows manufacture of a multilayer ceramic electronic component with high reliability.

Although one or more embodiments of the present disclosure have been described in detail, the present disclosure is not limited to the embodiments described above, and may be changed or varied in various manners without departing from the spirit and scope of the present disclosure. The components described in the above embodiments may be entirely or partially combined as appropriate unless any contradiction arises.

### REFERENCE SIGNS

1 multilayer ceramic capacitor
2 base component
3 external electrode
3A first external electrode
3B second external electrode
4 dielectric layer
5 internal electrode layer
51 end
6 dielectric protective layer (protective layer)
6a joint surface
7 main surface
7A first surface
7B second surface
8 end face
8A first end face
8B second end face
9 side surface (cleaning target surface)
9A first side surface
9B second side surface
10 ceramic green sheet
11 multilayer base
13 stack (base precursor)
15 imaginary separation line
18 support sheet (adhesive releasable sheet)
19 foreign object
20 laser device
21 laser beam
24 base
27 resin sheet
28 void

1. A multilayer ceramic electronic component, comprising:
a stack including dielectric layers and internal electrode layers alternately stacked on one another, the internal electrode layers including ends exposed on a side surface of the stack;
a dielectric protective layer covering the side surface; and
voids being between the dielectric protective layer and the ends, and having an average size less than or equal to a thickness of each of the internal electrode layers.

2. The multilayer ceramic electronic component according to claim 1, wherein
each of the internal electrode layers has a thickness of 0.4 to 1.0 μm inclusive.

3. The multilayer ceramic electronic component according to claim 1, wherein
the voids have an average size of 0.1 to 0.5 μm inclusive.

4. A method for manufacturing a multilayer ceramic electronic component, the method comprising:
preparing a stack including dielectric layers and internal electrode layers alternately stacked on one another, the internal electrode layers including ends exposed on a side surface of the stack, the ends extending in a first direction;
applying a laser beam to the side surface in a direction intersecting with the first direction at an incident angle greater than 0° and less than or equal to 90° with respect to the side surface to clean the side surface;
covering the cleaned side surface with a dielectric protective layer; and
firing the stack with the dielectric protective layer.

5. The method according to claim 4, wherein
the incident angle is greater than 30°.

6. The method according to claim 4, wherein
the laser beam travels in a direction at an angle greater than or equal to 60° with the first direction when viewed in a direction perpendicular to the side surface.
